(19) United States
(12) Patent Application Publication
(10) Pub. No.: US 2010/0010926 A1
(43) Pub. Date: Jan. 14, 2010

(54) SYSTEM, METHOD AND INSTRUMENT FOR MANAGING MARGIN REQUIREMENTS

(76) Inventors: Neil D. Eckert, Hailsham (GB); Richard L. Sandor, Chicago, IL (US); William G. Boyk, Naperville, IL (US); Robert C.B. Miller, London (GB)

Correspondence Address: WINSTON & STRAWN LLP;PATENT DEPARTMENT, 1700 K STREET, N.W., WASHINGTON, DC, 20006, US

(21) Appl. No.: 12/433,002

(22) Filed: Apr. 30, 2009

Related U.S. Application Data
(60) Provisional application No. 61/050,073, filed on May 2, 2008.

(51) Int. Cl. G06Q 40/00

(52) U.S. Cl. 705/37

(57) ABSTRACT

A method, media and system are directed to allocating a market risk for a trading participant. A computer-readable financial instrument is established based on a tradable commodity that is subject to an external risk or based on an event trigger for an anticipated environmental event that may cause harm to a geographic region; a health care risk for a geographic region, or a risk of enactment of a public policy that causes an economic impact to a geographic region. The instrument is traded between trading participants and a margin requirement for an account of at least one of the trading participants is determined based on an risk score for the instrument. Periodically, a change in the risk score is determined and the margin requirement is adjusted based on the change in the risk score.

This application claims the benefit of provisional application 61/050,073 filed May 2, 2008, the entire content of which is expressly incorporated herein by reference thereto.

### FIELD OF THE INVENTION

The present invention relates to a system, method, and media for managing margin requirements, and more particularly to managing margin requirements for financial instruments.

### BACKGROUND

Financial instruments can be created to address undesirable consequences to market participants from the occurrence of specified future events or conditions. An instrument sold by one participant to another participant forms a contract that upon the occurrence of the specified event or condition, a seller of the instrument would make a payment or deliver other resources and a buyer would receive a payment or other resources.

For example, environmental events may cause significant harm. The harm may occur within a geographical region. For example, storms may cause property damage, loss of lives, disruption of infrastructure, or the like. Water shortage may cause disruptions in industry, agriculture, governments, financial enterprises, fisheries, forestry, energy systems, and numerous other economic activities. Outbreaks of disease may cause loss of life, may drive up the price of health care products and services, or the like. Financial instruments may be used to manage the risk of these environmental events or conditions occurring and the subsequently caused harms or other impact that an entity may desire to mitigate. The instrument may be traded on an exchange. The exchange may be an organized exchange with specified hours of operation, trading rules, products, or the like.

When parties trade financial instruments, the closing of the transaction, or settlement, often occurs in the future and there is a risk that parties to a contract for a financial instrument will not perform their obligations under the contract. In order to decrease the risk of non-performance, exchanges may become involved in the transaction or interpose a third party, a clearing entity, in the transaction between the buyer and seller. The clearing entity or the exchange will guarantee the buyer's and seller's obligations under the contract, effectively assuming the obligations of both parties. Interposing the third party clearing entity and/or exchange into the transaction creates greater certainty that transactions will close, thereby eliminating settlement confusion and uncertainty. This market efficiency makes such markets more attractive to buyers and sellers, and adds to market liquidity.

As such, exchanges and/or clearing entities often require the trading participants to have an amount of funds available in an account (margin account) to secure performance on the financial instruments. To increase liquidity and to make the trading more attractive, exchanges may allow the participants to have an amount in their margin accounts at a determined amount that is less than a total amount to be paid for the traded instrument before the instrument settles. This determined amount is referred to as a margin requirement. Margin accounts may require full collateralization in excess of a premium for the sellers of the instrument, in some cases. However, the full collateralization requirement may be a conservative margining policy, and may discourage trading and may limit the liquidity of the instrument.

Environmental financial instruments may require a party to pay an amount if an environmental event causes a determined amount of property damage within a specified area. Environmental futures instruments, like other traded instruments, may benefit from margin management. It is with respect to managing margin for derivative financial instruments and other consideration that the present invention is directed.

### SUMMARY OF THE INVENTION

The invention relates to a computer-implemented method for allocating a risk of a non-performance for a trading participant. This method includes steps automatically performed by a computer-implemented exchange system that include establishing a computer-readable financial instrument based on a tradable commodity that is subject to anticipated event risks external to trading of the instrument or based on an event trigger for an anticipated event; providing a trade of the instrument between the trading participants; determining a margin requirement for an account of at least one of the trading participants based on an event risk score for the commodity or event; periodically receiving a change in the event risk score; and adjusting the margin requirement based on the change in the event risk score.

The event risks generally comprise a risk of an anticipated environmental event that may cause harm to a geographic region; a health care risk for a geographic region, or a risk of enactment of a public policy that causes an economic impact to a geographic region; and the event risk score correlates with the event risk or changes thereto. The anticipated event may be an anticipated environmental event, natural disaster or natural resource shortage. The health care risk may be the outbreak of a disease or a damaged or deteriorating environmental situation that causes a risk to the health of persons residing in the geographic region that is affected. The public policy action typically relates to one or more of natural resource access and usage; commodity or financial regulatory actions that influence prices and volume of trade, intellectual property protection; international relations; energy price regulations; tax rates and coverage; insurance programs; research and development support; or program expenditures, with the policy actions including actions by legislative, judicial, regulatory bodies, international agreements, election outcomes, or other observable events.

The instrument may be based on an environmental event trigger for an anticipated environmental event; with the margin requirement determined by establishing an environmental risk score for the anticipated environmental event; and determining a seller margin requirement for an account of the seller and a buyer margin requirement for an account of the buyer based on the environmental risk score for the anticipated environmental event. The determining of the margin requirement may also include periodically determining changes in the environmental risk score based on measurable factors that correlate to a likelihood of an occurrence of the anticipated environmental event; and adjusting the seller margin requirement and the buyer margin requirement based on either the change in the environmental risk score or when a determined date is reached.

A total margin requirement generally includes at least an aggregate percentage of a maximum contract value of the financial instrument with the adjusting further comprising determining the aggregate percentage based on the periodically determined environmental risk score. The environmental risk score can be based on a probability of the environmental event occurring with the adjusting further comprising determining the aggregate percentage based on the probability of the environmental event occurring. The environmental risk score can also be based on the determined date comprising a date within a period between Hurricane Seasons, a Pre-Hurricane Season, a Post-Hurricane Season, a Start of Hurricane Season, a Storm event, or a Post-Storm Period.

In a preferred embodiment, the determining of the margin further comprises adjusting the seller margin requirement and the buyer margin requirement, wherein a buyer/seller ratio between the buyer margin requirement and the seller margin requirement is determined at an initial ratio of a maximum contract value of the financial instrument; and modifying the buyer/seller ratio due to changes in the periodically determined environmental risk score, thereby further adjusting the seller margin requirement and buyer margin requirement. The adjusting of margin requirements may be performed when an estimate of damage caused by the event reaches a threshold, and the modifying of the buyer/seller ratio is set to a scheduled ratio when the modified periodically determined risk score reaches certain thresholds, with the scheduled ratio comprising an initial ratio wherein the seller has the greater proportion at a first threshold, an intermediate ratio where the buyer and seller have the same proportion at a second threshold, and a later ratio where the buyer has the greater proportion at a third threshold.

The event risk score can be determined by identifying measurable factors that correlate to a likelihood of the event; establishing a factor scoring model configured to provide a risk score based on historical trends of the measurable factors; testing the model for using the risk score to minimize the risk of the non-performance by adjusting a test margin based on the risk score; and providing the model to be used for adjusting margins, if the tested model minimizes the risk to a threshold.

The invention also relates to a processor readable medium for managing margin comprising instructions that when executed by processor causes the processor to perform the steps of the inventive method described herein.

Further, the invention relates to a computer-implemented exchange system for managing a market risk for a trading participant, comprising a user interface component for transceiving a fund for a margin trading account of the trading participant; and a trading interface in communication with the user component, wherein the trading interface is configured to perform the steps of the inventive method described herein.

### BRIEF DESCRIPTION OF THE DRAWINGS

FIG. 1 shows an example of a logical flow diagram for allocating a risk of non-performance for a trading participant.

FIG. 2A shows an example of one process for adjusting margin requirement(s).

FIG. 2B shows another example of one process for adjusting margin requirement(s).

FIG. 3 shows an example of one process for making a margin maintenance model.

FIG. 4 shows a method and system for allocating a risk of non-performance for a trading participant.

FIG. 5 shows a margin maintenance schedule for a pre-event season.

FIG. 6 shows a margin maintenance schedule for start of an event season.

FIG. 7 shows a margin maintenance schedule for a moderate threat of an event or condition occurring and/or causing damage.

FIG. 8 shows a margin maintenance schedule for a severe threat of the event or condition occurring and/or causing damage.

### DETAILED DESCRIPTION OF THE INVENTION

Generally, the present invention relates to a computer-implemented system, method, and media for allocating a margin requirement among trading participants. In one embodiment, the method includes establishing a computer-readable financial instrument that addresses the risk of an event or condition (hereinafter “risk of the event” or “event risk” as context permits) external to a trading of the instrument; providing a trade of the instrument between the trading participants; determining a margin requirement for an account of at least one of the trading participants based on an event risk score for the commodity; periodically receiving a change in the event risk score; and adjusting the margin requirement based on the change in the event risk score.

In one embodiment, the event risk score correlates with the event risk or condition occurring. The margin requirement may be adjusted based on the change in the event risk score. In preferred embodiments, the event risk includes a natural disaster risk, a natural resource shortage risk, a health care risk, a risk of a public policy action with economic impact, or the like. The public policy action may relate to one or more of natural resource access and usage; commodity or financial regulatory actions that influence prices and volume of trade, intellectual property protection; international relations; energy price regulations; tax rates and coverage; insurance programs; research and development support; or program expenditures. Alternatively, the public policy actions take the form of actions by legislative, judicial, regulatory bodies, international agreements, election outcomes, or other observable events.

In yet another embodiment, the method may include establishing a computer-readable financial instrument based on an event trigger for a type of an event; providing a trade of the instrument from a seller to a buyer at a price; and determining a seller margin requirement for an account of the seller and a buyer margin requirement for an account of the buyer based on an event risk score for the type of event.

In one embodiment, the system for allocating a risk of non-performance for a trading participant may include a user interface component for transceiving a fund for a margin trading account of the trading participant; a trading interface in communication with the user component; and/or a margin component. As used herein, the term “transceiving” means transmitting or receiving. In one embodiment, the fund may include an amount of money. In one embodiment, the trading interface may be configured to perform actions comprising: establishing a computer-readable financial instrument based on an environmental event trigger for a type of an environmental event; providing a trade of the instrument for the trading participant. The margin component of the system for managing the risk of non-performance of the buyer and/or seller may be configured to perform actions comprising determining a margin requirement for an account of the trading participant based on an environmental risk score for the type of environmental event. The margin component may be further configured to receive the environmental risk score from a plurality of sources.

In yet another embodiment, a processor readable medium for managing margin may include instructions that when executed by a processor causes the processor to perform actions. The actions may include establishing a computer-readable financial instrument based on an environmental event trigger for a type of an environmental event, a settlement function, a settlement value, and a settlement date; providing a trade of the instrument from a seller to a buyer at a price; and determining a margin requirement for an account of the trading participant based on a periodically determined environmental risk score for the type of environmental event. The actions may further include providing with the established instrument, a schedule of changes to the margin requirement based on the environmental risk score.

In yet another embodiment, a method is directed to making a model for allocating a risk of non-performance for a trading participant. The method may include identifying measurable factors or conditions (hereinafter “measurable factors”) that correlate to a likelihood of an event occurring; establishing a factor scoring model configured to provide a event risk score based on historical trends of the measurable factors; testing the model for using the event risk score to minimize the risk of non-performance by adjusting a test margin based on the event risk score; and providing the model to be used for adjusting margins, if the tested model reduces the risk to a threshold. The event risk may relate to any kind of event that affects the performance or a tradable financial instrument that is subject to a margin requirement. An exemplary event risk would be an environmental event risk may be identified with an event that causes a harm to a geographic region. The method may also include providing a trading of a financial instrument for managing the risk of the environmental event occurring; and implementing the provided model by adjusting a margin associated with the trading based on the provided model.

The invention more specifically relates to a computer-implemented method, system, and media for allocating a risk of non-performance for a trading participant. A computer-readable financial instrument may be established that addresses the risk of an event or condition external to a trading of the instrument. A trade of the instrument is provided between the trading participants. A margin requirement is determined for an account of at least one of the trading participants based on an event risk score for the type of event risk. Periodically, a change in the event risk score may be re-determined based on changes in external measurable factors that correlate to the likelihood of the event occurring. The margin requirement may be adjusted based on the change in the event risk score. These instruments can be derivative financial instruments that address any type of risk that a specified event or condition will occur, including environmental events or conditions.

As used herein, the term “market risk” refers to risk that the value of an instrument will change due to changes in market factors.

As used herein, the term “event” refers to any occurrence of a thing or condition. As used herein, the term “event risk score” refers to information representative of a probability that an event will occur (or not occur) based on measurable factors associated with the event. The event may include a natural disaster risk, a natural resource shortage risk, a health care risk, a risk of a public policy action with economic impact, or the like. The use of and monitoring of the public policy action with economic impact is described in U.S. patent application Ser. No. 12/060,782, entitled “INTEGRATION OF ENVIRONMENTAL CREDIT MECHANISMS INTO MUNICIPAL DEBT,” the content of which is expressly incorporated herein by reference to the extent necessary.

The term “environmental risk score” refers to information representative of a probability that an environmentally related event will occur based on measurable factors associated with the environmental event.

As used herein, the term “event trigger” refers to a Boolean condition, certainty factor, or other rule that if determined to be valid results in the conclusion that the event or condition related to the event has occurred. The term “environmental event trigger” refers to an event trigger for an environmental event. Environmental event triggers include Loss Trigger Levels (LTL).

As used herein, the term “non-performance” refers to the failure of a party to a contract to perform the terms of the contract.

The instrument may be established with a settlement function. For an environmental financial instrument, the settlement function of the instrument may be configured to provide $0 if the environmental event does not occur, or the payment of the entire underlying contract value if the environmental event does occur. The type of environmental event may include a storm damage, a property damage, or water shortage.

In one embodiment of the environmental financial instrument, the step of determining the margin requirements may further include periodically receiving information about external measurable factors used to determine an environmental risk score; making changes in the environmental risk score; and adjusting the seller margin requirement and the buyer margin requirement based on the change in the environmental risk score. The step of adjusting may be performed if a current date reaches a determined date. The determined date may include a date within a period between Hurricane Seasons, a Pre-Hurricane Season, a Post-Hurricane Season, a Start of Hurricane Season, a Storm event, or a Post-Storm Period.

In another embodiment of the environmental financial instrument, a total of the margin requirements may be adjusted or maintained at least an aggregate percentage of the underlying contract value. Adjusting may further include determining the aggregate percentage based on the periodically determined environmental risk score. In one embodiment, the environmental risk score may be based on a probability of the environmental event occurring and the adjusting further includes determining the aggregate percentage based on the probability of the environmental event occurring.

In yet another embodiment of the environmental financial instrument, determining the margin requirements may further include adjusting the seller margin requirement and the buyer margin requirement, wherein a buyer/seller ratio between the buyer margin requirement and the seller margin requirement is determined at an initial ratio and determined on a percentage of the underlying contract value. Adjusting may further include modifying the buyer/seller ratio based on the change in a periodically determined environmental risk score, thereby further adjusting the seller margin requirement and buyer margin requirement. In one embodiment, the modifying of the buyer/seller ratio may be performed if the modified periodically determined environmental risk score reaches a threshold.

In these embodiments, the buyer/seller ratio may be modified to a scheduled ratio when the modified periodically determined environmental risk score reaches certain thresholds, wherein the scheduled ratio includes an initial ratio wherein the seller has the greater proportion at a first threshold, an intermediate ratio where the buyer and seller have the same proportion at a second threshold, and a later ratio where the buyer has the greater proportion at a third threshold.

In yet another embodiment of the environmental financial instrument, adjusting the margin requirements may be performed if an estimate of damage caused by the environmental event reaches a threshold. This step may be performed after the environmental event has occurred. The step of adjusting may be based on the total margin requirements and/or buyer/seller ratio.

The steps and/or actions of the invention further include transferring from a seller of the instrument to a buyer of the instrument an amount based on the settlement value and the settlement function on the settlement date; and discounting any margin requirement for the instrument from a margin requirement of the seller or the buyer.

These steps and/or actions further include adjusting, on a determined date, the seller margin requirement and the buyer margin requirement, wherein a total of the margin requirements of parties participating in the trade is maintained at an aggregate percentage of the underlying contract value based on a periodically determined event risk score. For example, a the periodically determined environmental risk score can be determined, and the margin requirements maintained at a buyer/seller ratio based on the periodically determined environmental risk score. In one embodiment, the underlying contract value may be $10,000, but other contract values may be set or used without departing from the scope of the invention.

The invention also relates to a method, system, and media for creating and providing a model for allocating the risk of non-performance of parties to a derivative financial instrument.

In one embodiment, the current value of the financial instrument owned by the buyer is credited to amounts required to be deposited by the buyer as margin. As the value of the instrument changes from day-to-day relative to the margin requirement for the buyer, the buyer may be required to deposit additional funds for margin or may have excess margin in his account.

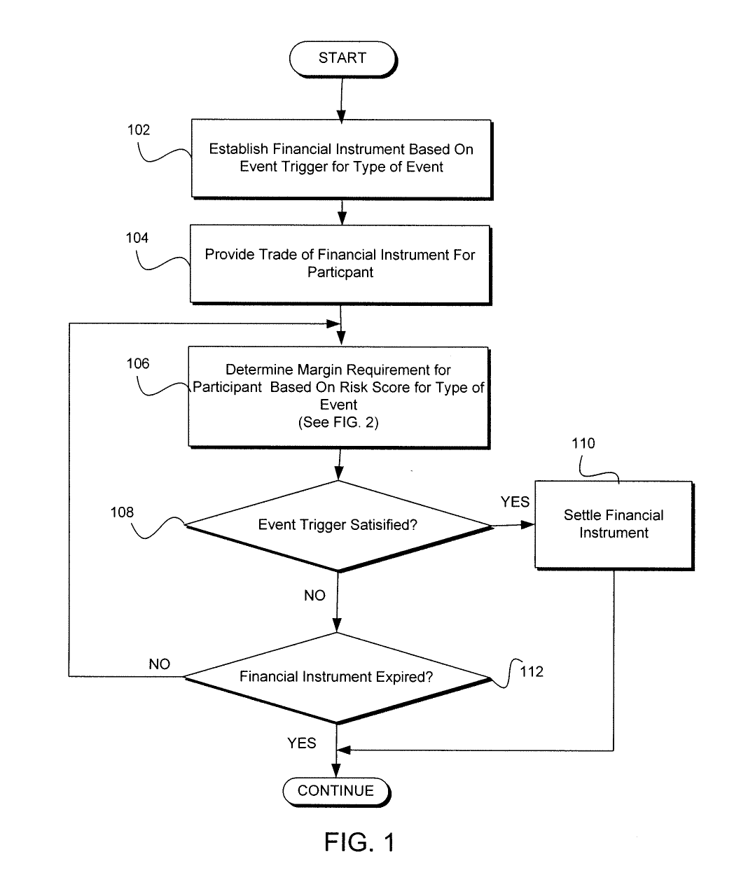

FIG. 1 shows a preferred example of a logical flow diagram for allocating a risk of non-performance for a trading participant. This example illustrates a preferred embodiment of the invention wherein margin requirements are adjusted based on the probability of occurrence of an anticipated environmental event, but of course the principles disclosed herein are applicable to other commodities or risks or rights relating to tradable commodities or financial instruments that are purchased subject to margin and the performance of which is subject to the occurrence of certain events.

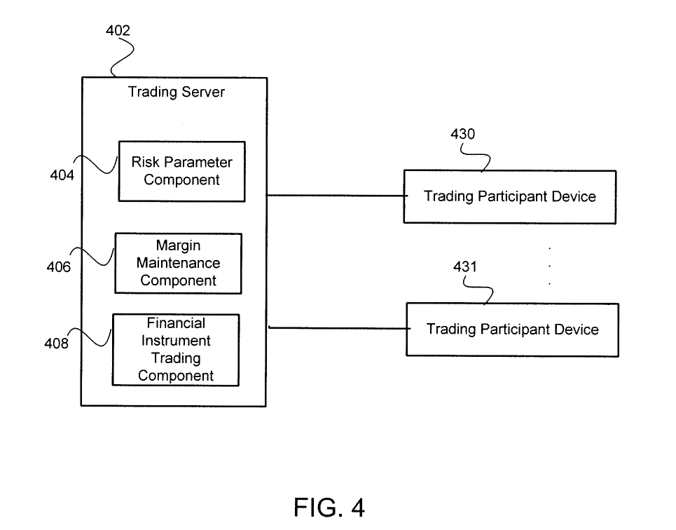

The process of FIG. 1 may be performed by server device 402 and/or client devices 430-431 of FIG. 4. At step 102, a computer-readable financial instrument may be established based on an event trigger for a type of an event. These instruments can be derivative financial instruments that address any type of risk that a specified event or condition will occur, including environmental events or conditions. In one embodiment, the financial instrument may also be configured with a settlement function, a settlement value, a settlement date, or the like. The financial instrument may be established in a computer readable media such as a disk, a main memory, on a network, or the like. The financial instrument may be a derivative instrument, a futures instrument, or the like. For convenience, a financial instrument based on an environmental event trigger is referred to as an “environmental financial instrument”. In one embodiment, the environmental financial instrument may be a futures instrument directed to allowing market participants to transact in catastrophic risk.

The environmental financial instrument may specify that a party is to receive a settlement amount if an environmental event trigger, including a Loss Trigger Level (LTL), is satisfied. That is if the environmental event causes a determined amount of property damage within the defined geographic areas specified by the contract specifications. In one embodiment, the LTL may be set at a predetermined level that corresponds to a total of the damage caused by the environmental event. For example, an LTL can be set at a $10 Billion (Bn), $20Bn, $30Bn, $40Bn, $50Bn damage in the US level, or the like. In an alternate embodiment, an instrument may be triggered for multiple levels, e.g., a first LTL of $10Bn pays a first amount, and a second LTL of $20Bn pays a second amount.

In one embodiment, environmental financial instruments may be traded as binary futures instruments on an exchange. For example, the instrument is either worth $10,000 at expiration (if a trigger event has occurred) or $0 at expiration (if a trigger event has not occurred).

Environmental financial instruments may have similar economic characteristics to Industry Loss Warranty (ILW) reinsurance policies with some key differences. But, environmental financial instruments need not be reinsurance contracts (e.g., buyers need not demonstrate any actual incurred losses; sellers need not be an authorized insurer or reinsurer). In one embodiment, environmental financial instruments may have standardized terms and the instruments/contracts may be listed on an organized exchange. The standardized terms and listing may enhance price transparency, eliminate counterparty credit issues, allow for unwinding Over the Counter (OTC) positions, or the like. In one embodiment, environmental financial instruments are subject to futures margin rules—so timing of cash receipts and payments may differ from conventional ILW reinsurance.

The environmental event addressed by the environmental financial instrument may be configured as a hurricane, a tropical storm, a wind event, a water shortage event, an outbreak of disease, or the like, a wind sub-zones (e.g., Florida, US North East), an earthquake, a typhoon, a monsoon or the like. The environmental event may be specified for a region, such as the U.S., Europe, Japan, or the like. In one embodiment, the specified environmental event includes an event that is the same as one defined by a conventional reinsurance policy and/or an instrument where the event is defined pursuant to negotiation.

For example, an environmental financial instrument may be for a US Tropical Wind Event. The environmental financial instrument may be listed on the exchange as, for example:
2007 First Event US Tropical Wind: $10Bn $20Bn, $30Bn, $40Bn and $50Bn LTLs
2008 First Event US Tropical Wind: $10Bn, $20Bn, $30Bn, $40Bn and $50Bn LTLs

As a further example, the 2007 First Event US Tropical Wind $10Bn LTL may represent: ‘The first US Wind Event occurring in 2007 which results in Insured Industry Losses (per PCS Reports) that is equal to or greater than $10Bn’. If Industry Losses for an event (e.g., US Tropical Wind Event) are equal to or greater than the specified LTL (e.g., $10Bn), an instrument settlement value is to be paid at $10,000. Otherwise, instrument settlement value is to be paid at $0. Two separate events (e.g., two separate hurricanes) which each have Industry Loss of $5Bn will not be aggregated to trigger the $10Bn LTL. In one embodiment, industry losses may be measured separately for each event (e.g., hurricane). Other examples of how the Event trigger may operate include:
A first 2007 tropical wind event causing $10.1 Bn of insured losses would trigger the First Event $10Bn LTL
A second 2007 tropical wind event causing insured losses of $20.1 Bn would trigger the Second Event $10Bn LTL and the First Event $20Bn LTL

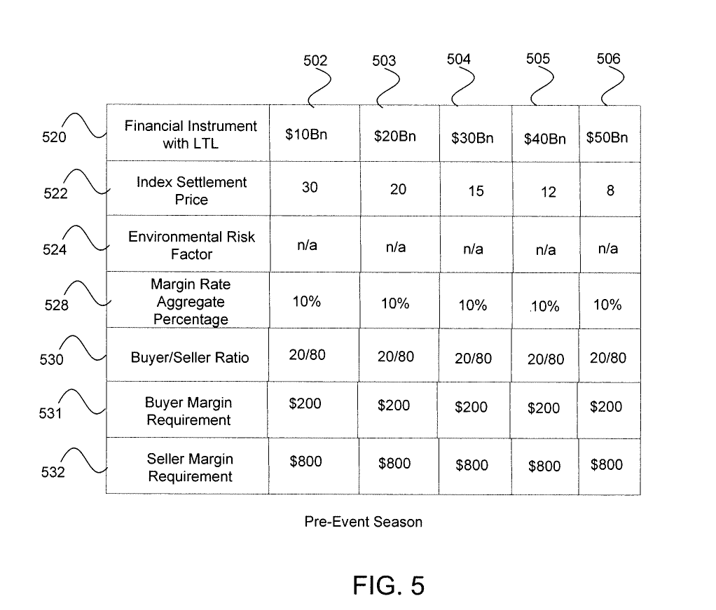

In one embodiment, a schedule of changes to the margin requirement based on an environmental risk score may be provided with the established instrument. The schedule may be the schedules shown in FIGS. 5-8. The schedules may be configured to adjust a margin requirement for a trader of the instrument.

The environmental financial instrument may be established with other parameters. In one embodiment, the instrument may be configured to be valid during a Contract Risk Period which may cover the calendar year of the contract year, e.g., Jan. 1 to Dec. 31, 2007 for the 2007 contract, or Jan. 1 to Dec. 31, 2008 for the 2008 contract. In one embodiment, events occurring during the Contract Risk Period are counted for that contract year. The insured loss estimating process (for events that occur during a Contract Risk Period) may also extend beyond the contract year-end.

At step 104, a trade of the instrument from a seller to a buyer at a price may be provided. In one embodiment, a party may sell one of the listed instruments on an exchange. The financial derivative instrument may be configured to allow market participants to transfer risks associated with the occurrence or non-occurrence of specified events. The price of such an instrument may be dependent on the likelihood of the occurrence of the specified event. In one embodiment, trading of the instrument may be enabled between a Starting Date and a Final Trading Day that are specified for the instrument. The Final Trading Day for positions may be 18 months following the close of the relevant Contract Risk Period. In one embodiment, the instrument may be settled at 100% of the stated contract value or $0 at that date.

For example, the seller may sell an instrument for a US Tropical Wind Event occurring in 2007 with a loss trigger of $10Bn with a price of $1,000 reached during a day between the Starting Date and Final Trading Day. The sale may be at a price determined by the market participants.

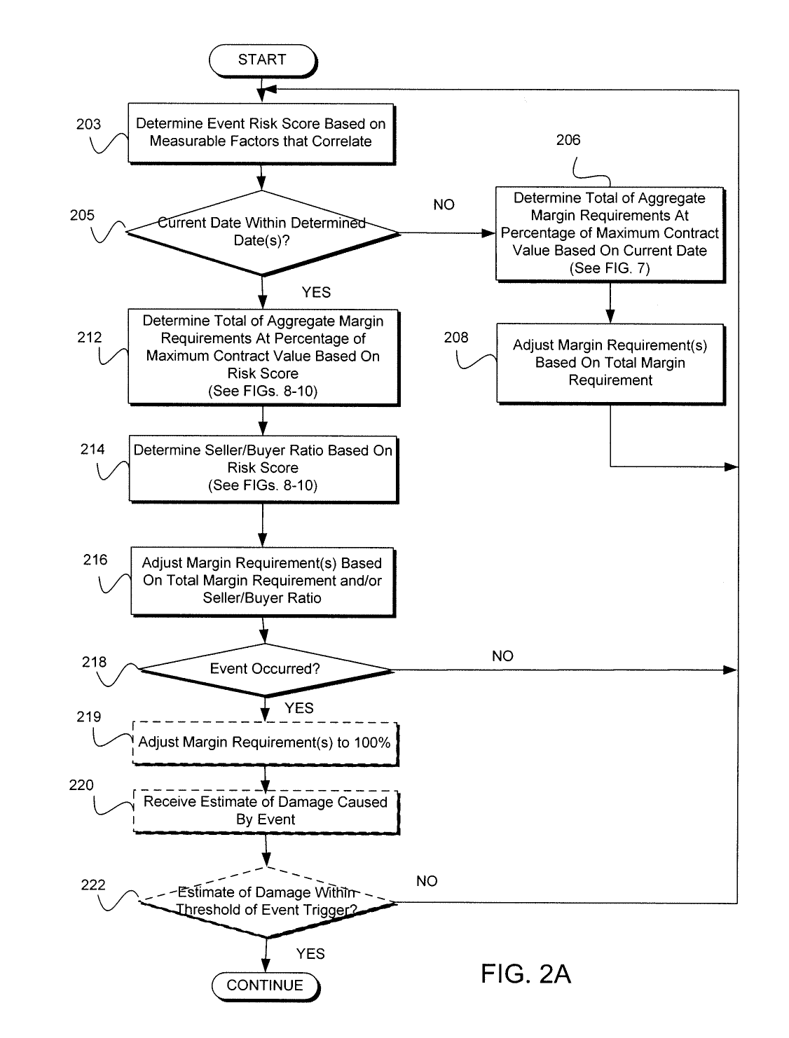

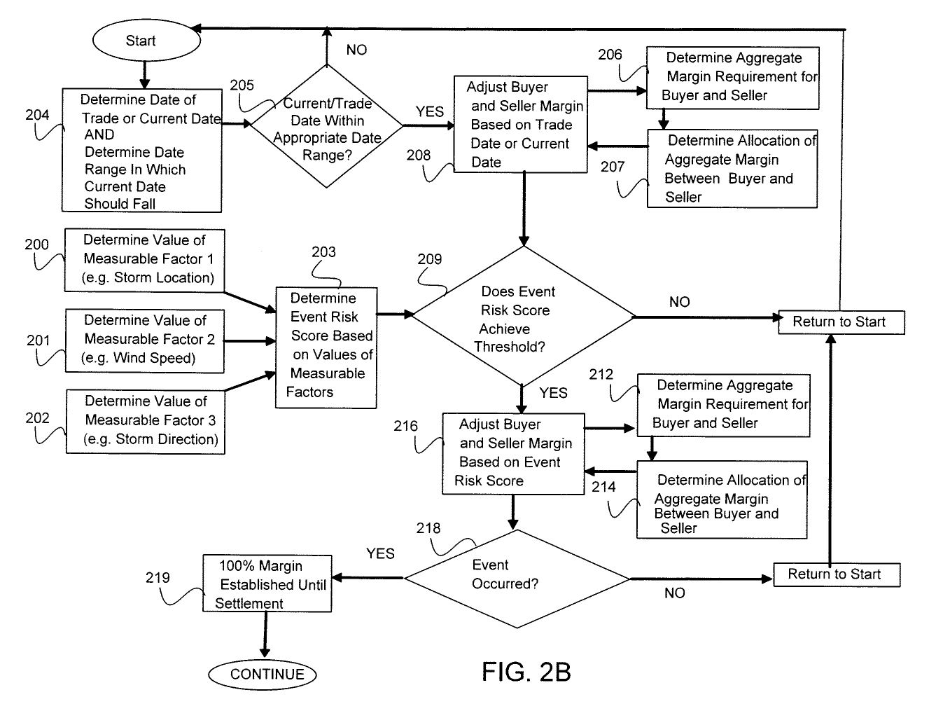

At step 106, a margin requirement may be determined for an account of at least one of the trading participants based on the environmental risk score. In one embodiment, a seller margin requirement may be determined for an account of the seller and a buyer margin requirement for an account of the buyer based on an environmental risk score for the type of environmental event. In one embodiment, the margin requirement may be set and adjusted based on an environmental risk score that is determined based on measurable factors that correlate with the likelihood that a hurricane or tropical storm will strike the United States and cause property damage. FIG. 2A or 2B shows an example of one process for adjusting the margin requirement(s).

At decision step 108, it is determined if the event trigger has been satisfied. The event trigger is satisfied if, for example, the event has occurred and the event has caused damage at the LTL specified in the instrument. If so, the instrument is settled at step 110. Otherwise, processing continues to step 112.

Alternately, in one embodiment, the exchange on which an instrument is traded may accelerate settlement of an instruments if results are known before a Last Trading Day of the instrument. For example, the instruments may be settled at step 110 if at least one of these events occurred: no eligible events have occurred as of the end of the Contract Risk Period; as of the last business day of the calendar year following the end of the subject Contract Risk Period the most recent interim property loss report issued for all applicable event(s) and estimates industry losses/damages below 75% and/or above 110% of applicable LTL.

At step 110, a contract for the financial instrument is settled. In one embodiment, the environmental financial instrument provides for payment if (but only if) industry-wide insured losses from a specified event reach a pre-specified LTL. In one embodiment, event losses are based on estimates of an independent third party entity such as Property Claims Service (PCS). The estimates may be received (e.g., by an organized exchange) over a network, over the Internet, or the like.

In one embodiment, settlement may include transferring from a seller of the instrument an amount based on the final value of the instrument, and transferring to the buyer of the instrument an amount based on the final settlement value, pursuant to the settlement function on the settlement date; and discounting any amounts held as margin requirement for the instrument from the respective obligations of the parties at settlement. After final settlement, the margin requirement for the financial instrument will cease to apply to the trading participants' accounts. For example, if an event had occurred that achieved the specified trigger level for the financial instrument, at settlement the seller may be required to deposit to her account any balance (in addition to margin) of funds necessary to settle the contract, and thereafter would have no requirement to maintain funds in her account as margin. At final settlement, the buyer of the instrument may be paid the pre-determined amount of money representing the settlement value if a US Tropical Wind Event causes property damage of at least $10Bn, and thereupon the buyer may withdraw all funds from his account. Processing then continues to other processing.

At decision step 112, it is determined if the financial instrument has expired. In one embodiment, the financial instrument may expire after a Final Trading Day specified in the established instrument. If the financial instrument has expired, processing continues to other processing. Otherwise, processing loops back to step 106. For example, after managing the margin requirement for an instrument for Event 1, the process is applied to Event 2. If prior to the end of the hurricane season, PCS finalizes a loss estimate on a storm that exceeds one or more LTLs on Event 1, then the above margin scenarios would be applied to settle contracts at each loss trigger level achieved.

FIGS. 2A and 2B show embodiments of a process for adjusting margin(s). The processes of FIGS. 2A and 2B may be performed by server device 402 and/or client devices 430-431 of FIG. 4.

At step 203, a change in a risk score is periodically determined. In one embodiment, the risk score may be an environmental risk score. One example of an environmental risk score is a risk score provided by an analysis of the probability of the event occurring based on measurable factors. In this embodiment, the environmental measurable factors may correlate to an environmental event of a particular type occurring. A plurality of measurable factors may be associated with the event that, if present or if present to some degree, indicate a likelihood that the event will occur (i.e., there is a correlation between the measurable factor and whether the specified event will happen). For example, if the event is a hurricane, the measurable factors can include wind strength, hurricane direction, speed of movement, etc. A methodology can be determined wherein the presence, level or other value of the measurable factors are used to determine a score (referred to herein as the “event risk score”) using appropriate calculations carried out by software. The Weather Channel and other weather prognosticators already try to predict the land area where it is likely that the hurricane will arrive using such measurable factors. A score derived from the measurable factors would be reflective of the likelihood of and event occurring. Other companies use different measurable factors or give more or less weight to the measurable factors for this purpose, and the resulting event risk score can be used to determine margins for participants in a derivative financial instrument transaction. One company, Risk Management Solutions Inc., is able to provide a software system that can carry out such calculations and determine and adjust a risk score.

At decision step 205, an event risk score is determined if a current date reaches or is within determined date(s). In one embodiment, the determined dates may comprise a date range, a time period between seasons of an event, or the like. In one embodiment, a determined date(s) may include the dates between hurricane seasons, the dates at a start of a hurricane season, a date within a hurricane season, or the like. In any case, if the current date is determined to reach or be within determined date(s), processing continues to step 212. Otherwise, processing continues to step 206.

At step 206, the total of margin requirements for at least one participant in the trade of the financial instrument is determined based on the current date. In one embodiment, if the current date is prior to a season for an event (e.g., pre-hurricane season), the total is set to a pre-determined value. The total may be set to a pre-determined aggregate percentage of the maximum contract value of the financial instrument. The step 206 may use various schedules to determine the total margin requirement.

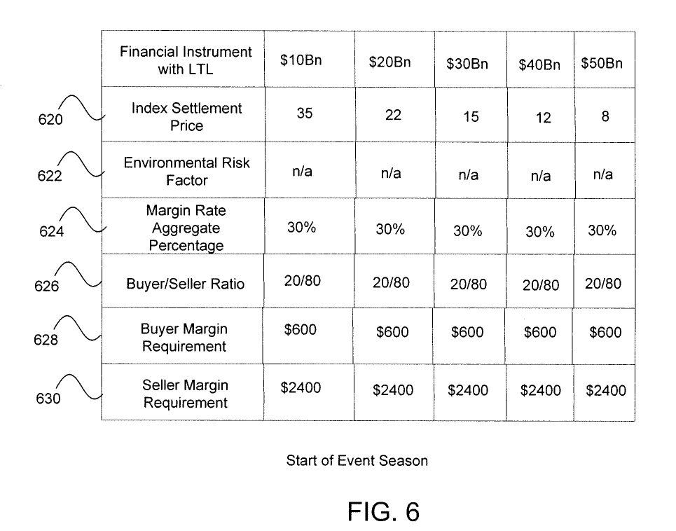

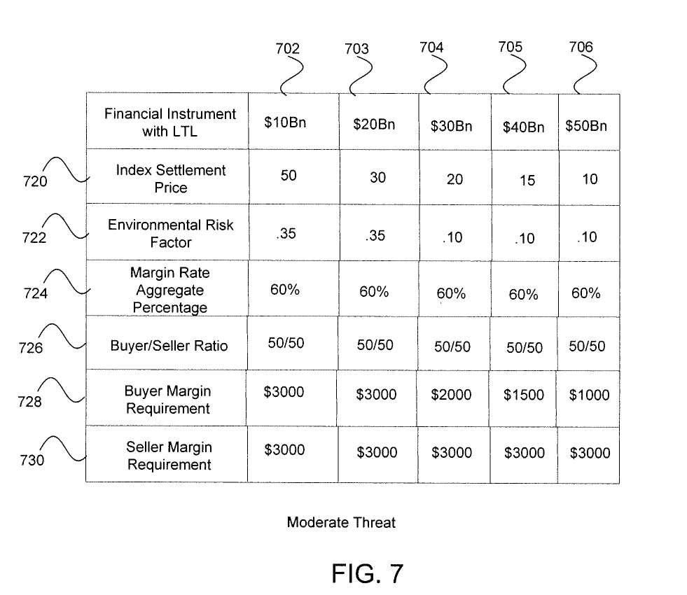

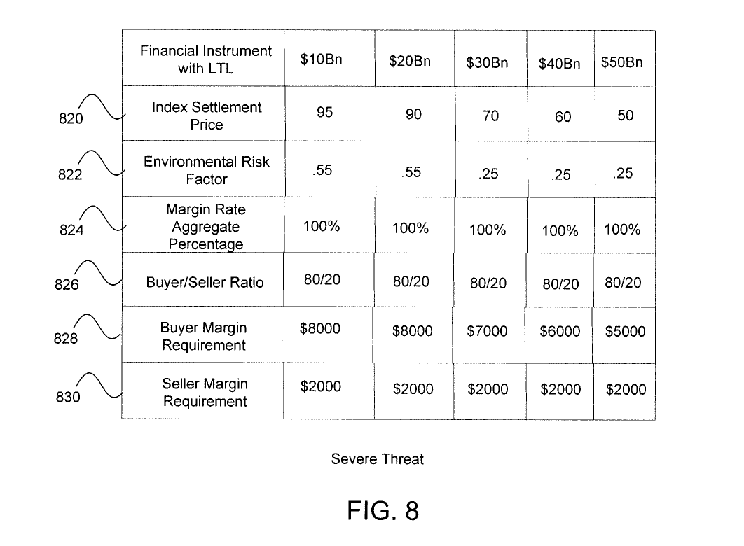

FIGS. 5-8 shows different schedules for margin requirements for different scenarios. The schedules apply to financial instruments with a maximum settlement value of $10,000 with different LTLs. For example, as shown, columns 702-706 of FIG. 7 show various values for financial instruments with the stated LTLs (i.e., $10Bn, $20Bn, etc.). The Index Settlement Price 522 of FIG. 5, 620 of FIG. 6, 720 of FIG. 7, and 820 of FIG. 8 are shown as index points, wherein each index point is worth $100.

Referring to FIG. 5, for the Pre-Event Season, such as a pre-hurricane season, the total of the buyer margin requirement and the seller margin requirement (“Margin Rate Aggregate Percentage” 528) is set at 10% of $10,000, or $1000. Accordingly, at step 206, using the schedule of FIG. 5, if the current date is in the pre-event season, the total of the buyer and seller margin requirement may be set to 10% of $10,000, or $1000.

Referring back to FIG. 2A, at step 208, the aggregate margin requirement for buyer and seller is adjusted or maintained based on the scheduled percentage of total value of the contract. Referring back to FIG. 5, the aggregate margin requirement may be divided between the buyer and seller based on a plurality of formulations. In one embodiment, the ratio between buyer/seller margin requirements 530 may be set for the Pre-Event Season at an initial ratio based on a percentage of the aggregate buyer and seller margin amount. For example, the aggregate buyer and the seller margin requirements are the Margin Rate Aggregate Percentage times the maximum contract value, allocated between the buyer and seller per the Buyer/Seller ratio. For example, for column 502, the buyer margin requirement 531 is (0.10*10,000)*0.20=$200. The seller margin requirement 532 is (0.10*10,000)*0.80=$800. Processing then loops back to step 203.

At step 212, an aggregate margin requirement of buyers and sellers at an aggregate percentage of the maximum contract value is determined based on the event risk score and/or the current date. Thereby, the aggregate margin requirement may be periodically (re)determined based on the event risk score and/or the current date. As shown, step 212 may be performed if the current date is approaching or after the start of an event season (e.g., approaching or after the start of a hurricane season) using various schedules, including the schedules at FIG. 5 or FIG. 6 to determine the total. Further adjustments may be made if the event risk score reaches certain levels.

Referring to FIG. 6, if the current date is at a start of hurricane season and/or the event risk score is below a first threshold (e.g., <0.35), the total of the aggregate buyer and seller margin requirements would be 30% of the maximum contract value pursuant to the Schedule in FIG. 6 (row 624). Although the event risk scores in FIG. 6 for all instruments of different LTLs are shown as “n/a”, in other embodiments, each instrument may have a different applicable percentage. In the instant case, as shown, the Start of Event Season aggregate buyer and seller margin is set to be 0.30*$10,000=$3000.

Referring to FIG. 7, if the event risk score 722 reaches the first threshold but not a second threshold (e.g., >=0.35 but <0.55 for a contract with a $10Bn LTL), the aggregate buyer and seller margin requirements 724 is set or modified to be 60% of the maximum contract value. As shown, the aggregate margin may be set to be 0.60*$10,000=$6000.

Referring to FIG. 8, if the event risk score 822 reaches or is above a second threshold but not a third threshold, (if one exists), (e.g., >=0.55 but <0.65), the aggregate buyer and seller margin requirements 824 is set or modified to be 100% of the maximum contract value. As shown, the aggregate margin may be set to be 1.0*$10,000=$10,000.

At step 214, a buyer/seller ratio between the buyer margin requirement and the seller margin requirement is determined. In one embodiment, the buyer/seller ratio may be modified to a scheduled ratio when the modified periodically determined risk score reaches certain thresholds, wherein the scheduled ratio comprises an initial ratio wherein the seller has the greater proportion at a first threshold, an intermediate ratio where the buyer and seller have the same proportion at a second threshold, and a later ratio where the buyer has the greater proportion at a third threshold. The step 214 may use various schedules to determine the buyer/seller ratio.

Referring to FIG. 6, if the environmental risk score 622 is not yet a component of the margin requirement determination because no event risk score is applicable (such as in FIG. 6 at the start of hurricane season), and/or the event risk score is below a first threshold (for example, an instrument with an LTL of $10Bn with a event risk score less than 0.35), the aggregate buyer and seller margin amount 624 is set at 30% and the buyer/seller ratio 626 is set at 20/80, or 20% of the aggregate margin requirements for the buyer and 80% of the aggregate margin requirements for the seller. In one embodiment, the buyer's margin requirement may be capped at the current price of the environmental financial instrument.

Referring to FIG. 7, if the environmental risk score 722 for an instrument reaches the first threshold and is less then or equal to the second threshold (e.g., 0.40), the aggregate buyer and seller margin amount 724 is set at 60% and the buyer/seller ratio 726 is set at 50/50, or 50% of the aggregate margin requirements for the buyer and 50% of the aggregate margin requirements for the seller. In one embodiment, the buyer's margin requirement may be capped at the current price of the environmental financial instrument. As shown, for the LTL $30Bn instrument, the buyer's margin requirement 728 is set to be 50% of $6000=$3000, and the seller's margin requirement 730 is set to be 50% of $6000=$3000 based on the buyer seller ration 726 if 50/50. However, if the current price of the subject financial instrument is $2,000, application of the cap will reduce the buyer's margin requirement 728 to $2,000.

By way of another example, referring to FIG. 8, if the environmental risk score 822 reaches or is above a second threshold but not a third threshold (if one exists) (e.g., >=0.55 but <0.65), the buyer/seller ratio 826 is set at 80/20 on aggregate buyer and seller margin of 100% of the maximum settlement amount, resulting in 80% of the maximum settlement amount ($8,000) for the buyer and 20% of the maximum settlement amount ($2,000) for the seller. In this embodiment, if the current price of the instrument was $7,000, the buyer's margin requirement may be capped at $7,000, the current price of the environmental financial instrument.

Referring back to FIG. 2A, at step 216, the margin requirement(s) are modified based on the determined aggregate of the margin requirement(s) and/or the buyer/seller ratio. Referring to FIGS. 6-8, the buyer's margin requirement is set appropriately as the buyer's share of the buyer/seller ratio of the total margin requirements, and the seller's margin requirement is set appropriately as the seller's share of the buyer/seller ratio of the total margin requirements. The buyer's margin requirement may be capped at the current price of the environmental financial instrument

At step 218, it is determined if the event has occurred. For example, it is determined if a storm has hit an area of the U.S. If so, processing continues to step 219. Otherwise, processing loops back to 203. At step 219, the aggregate margin requirement is set to 100%.

At step 220, an estimate of damage caused by the event is received. The estimate may be a loss estimate provided, received from or published by Property Claim Services (“PCS”), or any other damage assessment organization, including organizations recognized by an organized exchange.

At step 222, in a post-event period (e.g., discussed below) where it is reasonable to believe that an event has occurred but it has not yet been confirmed (e.g. an interim PCS report has indicated that damages are within reasonable proximity of the subject LTL, but a final report has not been issued that would determine whether or not the event has occurred in fact), the margin requirements of the parties may be maintained as if the event has occurred. In one embodiment, it may be determined if the estimate is within a damage range that is within reasonable proximity to (e.g., within a threshold of) the event trigger for the instrument. If at a later time it is determined that the damage threshold for a particular instrument is not met (e.g. the final PCS report specifies damages below the subject LTL), processing loops back to step 203, where the margin management requirements for traders of the subject financial instrument may be further modified based on new external measurable factors that result in a new event risk score, and determining a aggregate margin requirement and/or new buyer/seller ratio. Otherwise, processing maintains the current margin maintenance requirements and returns to other processing, such as step 108 of FIG. 1. In one embodiment, steps 219, 220 and/or 222 may be optional and may not be performed.

As one example of performing step 222, the damage range may begin at 75% of the $10Bn LTL of the financial instrument and control whether margin is maintained for both the $10Bn and $20Bn LTL. If the estimate is $7.5Bn, the damage estimate is within the range defined for maintaining margins for the $10Bn and $20Bn LTL, but the damage threshold for the other LTLs for the other instruments have not been met. For the $10Bn and the $20Bn LTL instruments, the margin requirement is maintained as is, but for the other instruments at higher LTLs, processing loops back to step 203, where the margin requirement(s) may be adjusted based on the changed event risk score.

FIG. 2B shows an alternate embodiment a process for adjusting margin(s). As shown, FIG. 2B performs similar steps as FIG. 2A, such steps denoted by similar step numbers. At step 204 a date of a trade of an event financial instrument and/or a current date is determined. Additionally, a date range in which the determined date should fall is also determined. The date range may be at least one of the date ranges corresponding to FIGS. 5-8.

At decision step 205, it is determined if the determined date is within the appropriate date range. If so, processing continues to block 208. Otherwise, processing loops back to step 204.

At step 208, the buyer and seller margins are adjusted based on the determined date. Step 208 may be performed by steps 206-207. At step 206, an aggregate margin requirement is determined for the buyer and seller based on the determined date. At step 207, an allocation of the aggregate margin requirement between the buyer and seller is determined based on the determined date. Processing then continues to step 209.

At decision step 209, it is determined if an event risk score has achieved a threshold (e.g., if the risk score is greater than or equal to the threshold). Step 209 may be performed by steps 200-203. As shown, steps 200-202 determine various measurable factors. Step 203 determines the event risk score based on the determined measurable factors. In any case, if the event risk score achieves the threshold, processing continues to step 216. Otherwise, processing returns to step 204.

At step 216, the buyer and seller margins are adjusted based on the event risk score. Step 216 may be performed by steps 212-214. At step 212, the aggregate margin requirement for the buyer and seller is determined based on the event risk score. At step 214, the allocation of the aggregate margin requirement between the buyer and seller is determined based on the event risk score. Processing then continues to decision step 218.

At decision step 218, it is determined if the event has occurred. If so, processing continues to step 219. Otherwise, processing loops back to step 204. At step 219, the aggregate margin requirement is set to 100% until settlement of the financial instrument. Processing then returns to other processing, such as step 108 of FIG. 1.

In an alternate embodiment, the process of FIG. 2 may be applied to financial instruments that can only occur after a previous event (Event 1) has occurred at the same LTL. In this embodiment, the aggregate of the margin requirement(s) and/or the buyer/seller ratio or a financial instrument for Event 2 may be determined based on the same event risk score, but reflecting the additional factor that requires that the first LTL for Event 1 has been satisfied (e.g., Event 1 has hit and there was a certain level of damage). The schedules of FIGS. 6-8 may take into account the additional factors.

For example, if neither a first storm nor a second storm has developed, the aggregate margin amounts and/or the buyer/seller ratio for an Event 2 financial instrument may be determined based on the schedule of FIG. 6. If the first storm has developed, but the second storm has not yet developed, the schedule of FIG. 6 may still be used for Event 2.

If the first storm is approaching a region, the event risk score for Event 1 may be “severe”, but the probability of a second Event 2 may be lower. The event risk score for Event 2 may be at a “moderate” level, for example. Accordingly, the aggregate margin amount and/or the buyer/seller ratio for an Event 2 financial instrument may be determined at the levels of the schedule of FIG. 7.

If the first storm has hit and/or the LTL for Event 1 has been triggered, and the second storm has not yet developed (e.g., a low event risk score), the schedule of FIG. 7 may be used for Event 2's margin, or even the schedule of FIG. 8. If the second storm has developed and its event risk score is within a specified range, the schedule of FIG. 8 may be used for Event 2's margin. The margin requirements may increase to 100% if the storm for Event 2 actually occurs.

For settlement of the event, the number of the event (Event 1 or Event 2) may be based on the timing of a final determination of whether an LTL level has been reached (e.g., when PCS issues its final report), regardless of when the event occurs. So, for example, if an event occurs, it would tentatively be deemed Event 1. However, if a second event occurs and the final report for the later in time event is issued before the final report for the earlier in time event, the later in time event would be deemed Event 1. The financial instruments may remain unsettled for a period of time after the subject events actually occur. Accordingly, early settlement may be provided under certain circumstances.

These scenarios are embodiments of possible applications of the additional factors. However, any other schedules including different buyer/seller ratios and aggregate margin amounts may be used for adjusting the margins based on the event risk score of the event and the event risk score of another event and/or a determination of whether the other event occurred at an appropriate LTL level.

As a further example of one application of one embodiment of the process of FIGS. 2A-2B, the margins may be adjusted for a plurality of time periods: Pre- and Post-Hurricane Season, Start of Hurricane Season, Storm and Post-Storm. In one embodiment, the seasons are as defined below, but any time periods may be used without departing from the scope of the invention.

1) Pre-Hurricane Season: January 1 of the year prior to the Contract Risk Year, through May 31 of the Contract Risk Year (17 months)

2) Start of Hurricane Season: June 1 of the Contract Risk Year

3) Hurricane Season: June 1 through November 30 of the Contract Risk Year

4) Moderate Risk: an event risk score of 0.35 or greater has been determined

5) Severe Risk: an event risk score of 0.55 or greater has been determined

6) Post-Storm Period: once a storm hits land and PCS issues a report, no more event risk scores are issued (during this period, it is simply a matter of damage amounts to be determined by PCS)

For a $10Bn LTL: during the 17 months from January 1 of the calendar year prior to the Contract Risk Year until June 1 of the Contract Risk Year, the Pre-Hurricane Season margin requirements applies (FIG. 5). When the Hurricane Season begins on June 1 of the Contract Risk Year, margin requirements of FIG. 6 applies. FIG. 6 applies during the entire season if no event risk scores are reported that equal or exceed 0.35 (this level is different for $30Bn, $40Bn and $50Bn LTL contracts). If a 0.35 or greater score is reported, the Moderate Threat chart applies (FIG. 7). FIG. 7 applies until the score is reduced below 0.35 or until it goes to 0.55 or greater (this level is different for $30Bn, $40Bn and $50Bn LTL contracts), in which case the Severe Threat chart applies (FIG. 8).

Once the storm hits land and a PCS report is issued, no more scores are calculated. This begins the Post-Storm Period. For purposes of margins, once in the Post-Storm period (and no final report has been issued), the damage estimate determines how the LTL margins will be dealt with based on the damages as a percentage of the $10Bn and $30Bn LTL. If the estimated damages are 75% or greater than the $10Bn LTL (i.e. $7.5 Bn), both the $10Bn and the $20Bn aggregate margins remain at 100% of maximum contract value (until the final report is issued). If the estimated damages are 75% or greater than the $30Bn LTL (i.e. $22.5Bn), each of the $30Bn, $40Bn and $50Bn aggregate margins stay at 100% of maximum contract value (until a final report is issued).

As yet another example of one application of one embodiment of the process of FIGS. 2A-2B, a margin schedule may provide for adjustable margins for the North Atlantic hurricane season (June 1 to November 30). Margin schedules for eastern Pacific tropical storms and hurricanes that threaten Hawaii and the U.S. West Coast may be similarly established. The adjustable margin model for the hurricane season assesses the likelihood that tropical storms and hurricanes could generate significant insured losses and trigger any of the environmental financial instrument LTLs (i.e., $10Bn, $20Bn, $30Bn, $40bn and $50Bn), and then serves as a basis for determination of appropriate margins for buyers and sellers of instruments with the applicable LTLs.

The schedules shown below identify four stages of margin: Pre- and Post-Hurricane Season, Start of Hurricane Season, Storm and Post-Storm. Margin levels are flat rates that will change within the four stages and will also shift the risk accordingly between buyers and sellers.

Pre- and Post-Hurricane Season Margins

| | Buyer | Seller |
|---|---|---|
| Event 1: | $200 | $800 |
| Event 2: | $100 | $400 |

Start of Hurricane Season Margins

| | Buyer | Seller |
|---|---|---|
| Event 1: | $600 | $2,400 |
| Event 2: | $200 | $800 |

Storm Margins Moderate Threat: (A storm has a moderate potential to cause insured property losses equal to one or more LTLs.)

| | Buyer | Seller |
|---|---|---|
| Event 1: | $3,000 | $3,000 |
| Event 2: | $200 | $800 |

Storm Margins Severe Threat: (A storm has a reasonable potential to cause insured property losses equal to one or more LTLs.)

| | Buyer | Seller |
|---|---|---|
| Event 1: | $8,000 | $2,000 |
| Event 2: | $200 | $800 |

In one embodiment, a scoring system quantifies the risk that a tropical storm or hurricane will cause insurance losses that will reach LTLs. The scores calculated may be based on the speed, strength, direction and location of the relevant storms in the North Atlantic. In one embodiment, an exchange, a governmental entity, or other third party may administer and/or provide the scoring system if tropical storms are present in the North Atlantic. The scoring system and/or other information related to the scores may be provided over a network, such as the Internet.

Post-Storm Margins

Margin levels after a tropical storm or hurricane will be dependent on the loss estimates published by Property Claim Services (“PCS”), or any other damage assessment organization, including organizations recognized by an exchange.

When it is apparent that insured property losses will not exceed 75% of LTLs, margins will revert to the Start of Hurricane Season levels.

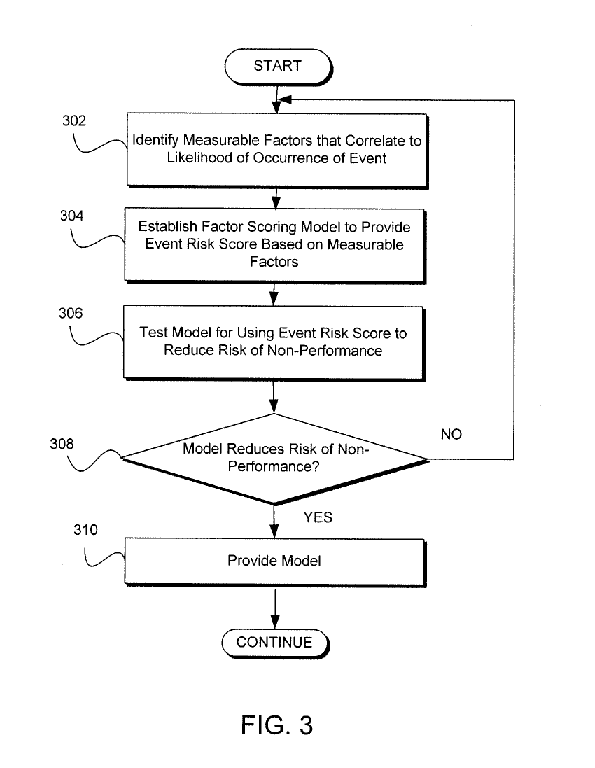

The environmental risk scores described in FIGS. 1-2 may be provided by any margin maintenance model. FIG. 3 shows an example of one process for making such a margin maintenance model. The process of FIG. 3 may be performed by server device 402 and/or client devices 430-431 of FIG. 4.

At step 302, measurable factors or characteristics (hereinafter “measurable factors”) such as wind speed, direction, etc., are identified that correlate to the likelihood of an environmental event, such as hurricanes or tropical storms causing damage in the United States (e.g., measurable factors, that when certain results are achieved indicate in this case, a greater likelihood of damage from hurricanes or tropical storms).

At step 304, a measurable factor scoring model is established. In one embodiment, the model may be configured to use measurable factors values based on historical trends of the measurable factors. In one embodiment, the model may comprise a plurality of conditional probabilities based on historical correlations between past measurable factors or conditions, and a likelihood of damage caused by the subject environmental events. In one embodiment, the model may comprise a formula or other methodology that would use information about the degree to which the presence or absence or level of the measurable factors and generate the measurable factors into a score that is an indicator of the likelihood of the happening of the environmental event.

A margin management model may comprise a plurality of rules, formulas, or the like, configured to provide at least one event risk score based on a plurality of measurable factors for a type of an environmental event.

At step 306, the model for using the event risk score to minimize the risk of non-performance by parties to a transaction in a financial instrument is tested by adjusting a test margin based on the score. The rules may be tested based on various weighing of the environmental characteristics or factors, modeling, or the like. The tested model may also be applied to environmental event data to determine the accuracy of predictions of the environmental event occurring and/or historical information about failures to make margin calls correlated with environmental measurable factors and resulting environmental event risk score(s).

At step 308, it is determined if the model minimizes a risk of non-performance of buyers and sellers in a transaction involving a derivative financial instrument. In one embodiment, the model minimizes the risk of non-performance if the model's prediction of missed margin calls correlated with environmental risk score is above a threshold. If the model minimizes the risk of non-performance, processing continues to step 310. Otherwise, processing loops back to step 302.

At step 310, the model is provided. The provided model may be used to adjust margin requirements, for example at step 106 of FIG. 1 and/or the process of FIG. 2A or 2B.

FIG. 4 shows another method and system for allocating a risk of non-performance for a trading participant. In one embodiment, the system of FIG. 4 provides a market-based contractual mechanism that allows the transfer of environmental damage risks from particular geographic regions from those who bear the economic risk from such events, to those financial and investor agents that are willing to accept such risks. The contractual instruments may be traded on an organized exchange, using for example, financial instrument trading component 408. In other embodiments, the instruments may also be traded in other markets such as through private, over-the-counter trades, as instruments offered by banking and investment institutions.

The organized exchange can include a system for facilitating trading between parties. The system can include a trading host or platform, such as server device 402, a registry, and a guarantee mechanism. The system can be coupled to a network, such as the Internet or any other public or private network or connections of computing devices.

The trading platform 402 includes an electronic mechanism for hosting trading of financial instruments that provides participants with a central location that facilitates trading, and publicly reveals price information. The trading platform reduces the cost of locating trading counter parties and finalizing trades, important attributes of an efficient market. In one embodiment, parties using client devices 430-431 may receive information about tradable instruments, may send buy or sell orders for the instruments to sever device 402, or the like.

The traded derivative financial instruments may be established using environmental risk parameter component 404. The traded derivative financial instruments, which preferably are in the form of futures or options contracts, may also be the basis of spot contracts, swap contracts, swaptions, mutual funds, bonds, and all such related contracts that have a price, return, dividend, equity instruments and other derivative instruments, or other financial performance that is based on water supply quantity in a particular geographic region.

In one embodiment, margin component 406 may maintain a margin amount for at least one account for at least one trading participant. In one embodiment, the margin amount for an account of a party participating in a trade of the financial instrument may be determined based in part on an environmental risk score determined on a date of the trade, periodically, or the like. Margin component 406 may be configured to perform the process of FIGS. 1-3 as described above.

Although FIGS. 1-4 describes processes and systems for managing the risk of non-performance for a participant trading an environmental event financial instrument by adjusting margins based on an environmental event risk score, the processes and system may be modified to be applicable to any event or condition based financial instrument, any event risks, and any event risk measurable factors, without departing from the scope of the invention.

The financial instruments may be configured to provide payments for any event or condition occurrence or non-occurrence. The financial instruments may include futures commodities, for example. The event risk score may be based on measurable factors associated with the event that correlate with the probability of the event occurring or not occurring. The measurable factors or characteristics may be external to a trading of the instrument. Examples of a financial instrument and associated measurable factors includes: crop futures and any measurable factors representative of a drought or flood in crop producing regions, water futures and any measurable factors that indicate low water levels in a region, carbon derivatives and the factors that may indicate a change in a governmental regulation of carbon emitters in a region, or the like.

Other financial instruments that are purchased subject to margin can be processed utilizing the invention. For example, the margin requirements for purchasing a common stock or other commodity can be subjected to an analysis of external events to determine whether the margin should be adjusted. Such external events could include purchase or sales of other entities, failure to meet earnings projections, or loss of sales due to events that are outside of the company's control, such as strikes, production failures, recalls of products, etc.

Similarly, other financial instruments can be devised which are similar to the financial instrument exemplified above for determining margin requirements for the risk of an anticipated environmental event such as a hurricane. Such instruments can be based on the possibility of a health care risk such as the outbreak of a disease or a damaged or deteriorating environmental situation that causes a risk to the health of persons residing in the geographic region that is affected based on the disease. As noted herein, the financial instruments may be configured to provide payments for any event or condition occurrence or non-occurrence.

Note that any of the functions, method steps, or processes of the invention can be performed by one or more hardware or software devices, processes, or other entities. These entities can reside in the same location or can reside remotely as, for example, entities interconnected by a digital network such as the Internet, a local area network (LAN), campus or home network, standalone system, etc. Although functions may have been described as occurring simultaneously, immediately or sequentially, other embodiments may perform the functions, steps or processes in a different order, or at substantially different times with respect to execution of other functions, steps, or processes.

It will be understood that the systems and software described herein include, either explicitly or implicitly, software implemented on computers or other appropriate hardware, including such other intelligent data processing devices having processors, data storage means, and the ability to support an operating system, with or without user interfaces, for example, file servers, as may be useful in implementing this invention.

Preferred embodiments of the invention provide program product, which can cause a general-purpose computer to operate as a special-purpose computer, in accordance with the disclosure herein. Such program product implemented on a general-purpose computer, in accordance with the disclosure herein. Such program product implemented on a general-purpose computer constitutes an electronic customizing machine that can interact with a magnetically or optically cooperative computer-based input device enabling the computer to be customized as a special purpose computer, according to the contents of the software. To cause a computer to operate in such a customized, special-purpose mode, the software can be installed by a user or some other person, and will usually interact efficiently with the device on which it resides to provide the desired special-purpose functions or qualities, and/or after the selection of configuration parameters which are often unique to the operating system(s) used by the computer. When so configured, the special-purpose computer device has an enhanced value, especially to the professional users for whom it may be intended.

It is to be understood that the terms “device”, “computer”, “server”, “data storage means,” as well as cognate terms, denote either physical or logical instances of those entities. For instance, a computer, data storage means and server may be implemented as separate physical entities or as one physical entity performing logically separate functions. Similarly two servers may be implemented as separate physical entities or as one physical entity performing logically separate functions. Also, a computer may be envisaged as a “terminal” which will be understood to include mobile devices (e.g., mobile phones or PDAs) as well as stationary computers.

What is claimed is:

1. A computer-implemented method for allocating a risk of a non-performance for a trading participant, which comprises steps automatically performed by a computer-implemented exchange system that include:
establishing a computer-readable financial instrument based on a tradable commodity that is subject to anticipated event risks external to trading of the instrument or based on an event trigger for an anticipated event;
providing a trade of the instrument between the trading participants;
determining a margin requirement for an account of at least one of the trading participants based on an event risk score for the commodity or event;
periodically receiving a change in the event risk score; and
adjusting the margin requirement based on the change in the event risk score.

2. The method of claim 1, wherein the event risks comprise a risk of an anticipated environmental event that may cause harm to a geographic region; a health care risk for a geographic region, or a risk of enactment of a public policy that causes an economic impact to a geographic region; and the event risk score correlates with the event risk or changes thereto.

3. The method of claim 1, wherein the anticipated event is an anticipated environmental event, natural disaster or natural resource shortage; the health care risk is the outbreak of a disease or a damaged or deteriorating environmental situation that causes a risk to the health of persons residing in the geographic region that is affected; or the public policy action relates to one or more of natural resource access and usage; commodity or financial regulatory actions that influence prices and volume of trade, intellectual property protection; international relations; energy price regulations; tax rates and coverage; insurance programs; research and development support; or program expenditures, with the policy actions including actions by legislative, judicial, regulatory bodies, international agreements, election outcomes, or other observable events.

4. The method of claim 1, wherein the instrument is based on an environmental event trigger for an anticipated environmental event; and the margin requirement is determined by establishing an environmental risk score for the anticipated environmental event; and determining a seller margin requirement for an account of the seller and a buyer margin requirement for an account of the buyer based on the environmental risk score for the anticipated environmental event.

5. The method of claim 4, wherein the determining of the margin requirement further comprises:
periodically determining changes in the environmental risk score based on measurable factors that correlate to a likelihood of an occurrence of the anticipated environmental event; and
adjusting the seller margin requirement and the buyer margin requirement based on either the change in the environmental risk score or when a determined date is reached.

6. The method of claim 5, wherein a total of the margin requirements is at least an aggregate percentage of a maximum contract value of the financial instrument and the adjusting further comprises determining the aggregate percentage based on the periodically determined environmental risk score.

7. The method of claim 6, wherein the environmental risk score is based on a probability of the environmental event occurring and the adjusting further comprises determining the aggregate percentage based on the probability of the environmental event occurring; or is based on the determined date comprising a date within a period between Hurricane Seasons, a Pre-Hurricane Season, a Post-Hurricane Season, a Start of Hurricane Season, a Storm event, or a Post-Storm Period.

8. The method of claim 1, wherein the determining of the margin further comprises:
adjusting the seller margin requirement and the buyer margin requirement, wherein a buyer/seller ratio between the buyer margin requirement and the seller margin requirement is determined at an initial ratio of a maximum contract value of the financial instrument; and
modifying the buyer/seller ratio due to changes in the periodically determined environmental risk score, thereby further adjusting the seller margin requirement and buyer margin requirement.

9. The method of claim 8, wherein the adjusting of the margin requirements is performed when an estimate of damage caused by the event reaches a threshold, and the modifying of the buyer/seller ratio is set to a scheduled ratio when the modified periodically determined risk score reaches certain thresholds, wherein the scheduled ratio comprises an initial ratio wherein the seller has the greater proportion at a first threshold, an intermediate ratio where the buyer and seller have the same proportion at a second threshold, and a later ratio where the buyer has the greater proportion at a third threshold.

10. The method of claim 1 wherein the event risk score is determined by identifying measurable factors that correlate to a likelihood of the event; establishing a factor scoring model configured to provide a risk score based on historical trends of the measurable factors; testing the model for using the risk score to minimize the risk of the non-performance by adjusting a test margin based on the risk score; and providing the model to be used for adjusting margins, if the tested model minimizes the risk to a threshold.

11. A processor readable medium for managing margin comprising instructions that when executed by processor causes the processor to perform the steps of the method of claim 1.

12. A computer-implemented exchange system for managing a market risk for a trading participant, comprising:
a user interface component for transceiving a fund for a margin trading account of the trading participant; and
a trading interface in communication with the user component, wherein the trading interface is configured to perform the steps of the method of claim 1.
